(19) United States
(12) Patent Application Publication
(10) Pub. No.: US 2026/0105154 A1
(43) Pub. Date: Apr. 16, 2026

(54) INDEPENDENTLY ATTESTABLE INITIALIZATION OF INFORMATION HANDLING SYSTEMS

(71) Applicant: Dell Products L.P., Round Rock, TX (US)

(72) Inventors: Marshal F. Savage, Austin, TX (US); Kiran Vetteth, Leander, TX (US); Juan Francisco Diaz, Round Rock, TX (US)

(73) Assignee: Dell Products L.P., Round Rock, TX (US)

(21) Appl. No.: 18/914,721

(22) Filed: Oct. 14, 2024

(51) Int. Cl. G06F 21/57

(52) U.S. Cl. CPC G06F 21/575

(57) ABSTRACT

Systems and methods support independent attestation of portions of boot code used by an Information Handling System (IHS). The IHS includes a processor that is configured to identify, upon booting of the IHS, one or more partitions of a memory device that store boot code of the IHS. In particular, the processor is configured to identify partitions of the memory device that comprise independently attestable boot code, where an independently attestable partition designates an attestation protocol for use in validating the boot code of an individual partition. The processor is further configured to utilize an attestation protocol designated for each independently attestable partition for validating boot code of an individual partition. In this manner, different portions of the boot code of an IHS may be independently validated in a scalable manner.

### FIELD

This disclosure relates generally to Information Handling Systems (IHSs), and more specifically, to secure initialization of IHSs.

### BACKGROUND

As the value and use of information continues to increase, individuals and businesses seek additional ways to process and store information. One option is an Information Handling System (IHS). An IHS generally processes, compiles, stores, and/or communicates information or data for business, personal, or other purposes. Because technology and information handling needs and requirements may vary between different applications, IHSs may also vary regarding what information is handled, how the information is handled, how much information is processed, stored, or communicated, and how quickly and efficiently the information may be processed, stored, or communicated. The variations in IHSs allow for IHSs to be general or configured for a specific user or specific use such as financial transaction processing, airline reservations, enterprise data storage, global communications, etc. In addition, IHSs may include a variety of hardware and software components that may be configured to process, store, and communicate information and may include one or more computer systems, data storage systems, and networking systems.

IHSs, such as rack-mounted servers, may be initialized using boot code instructions that may be include the BIOS (Basic Input/Output System) and/or UEFI (Unified Extensible Firmware Interface) of the IHS. Upon being powered, these boot code instructions may be operated to initialize critical hardware components of the IHS, such as memory, CPU, and storage devices, and may also verify that these hardware components are operating correctly. Once a requisite amount of hardware has been initialized and validated as part of the root of trust of the IHS, the boot code instructions of the IHS may initiate bootloader programs that may boot and hand over control to the kernel of the operating system of the IHS, which completes the boot process by initializing system services and loading drivers, thus bringing the IHS to an operational state.

### SUMMARY

In various embodiments, systems and methods include an Information Handling System (IHS) that include: one or more processors; a memory device coupled to the one or more processors, the memory device storing instructions that, upon loading and execution by a first of the processors upon booting of the IHS, causes the first processor to: identify one or more partitions of the memory device that store boot code of the IHS; identify partitions of the memory device that comprise independently attestable boot code, wherein an independently attestable partition designates an attestation protocol for use in validating boot code of the respective partition; and utilize an attestation protocol designated for each independently attestable partition for validating boot code of a respective partition.

In some embodiments, the boot code of a partition is validated through comparison of a measurement of the boot code versus a reference measurement for the boot code of the partition. In some embodiments, the attestation protocol designated for an independently attestable partition specifies the first processor of the IHS to perform the measurement of the boot code. In some embodiments, the first processor comprises a CPU of the IHS and wherein the CPU generates the measurements of the boot code. In some embodiments, the first processor comprises a TPM of the IHS, and wherein a remote access controller invokes the TPM of the IHS to generate the measurements of the boot code. In some embodiments, when the boot code stored in an independently attestable partition is validated, the boot code is added to a root of trust of the IHS. In some embodiments, the boot code comprises BIOS (Basic Input/Output System) instructions. In some embodiments, a first independently attestable partition of the memory device that stores BIOS instructions comprises instructions for initialization of a first hardware device of the IHS and wherein a second independently attestable partition of the memory device that stores BIOS instructions comprises instructions for initialization of a second hardware device of the IHS. In some embodiments, the first independently attestable partition comprising instructions for the first hardware device is validated using a first attestation protocol, and wherein the second independently attestable partition comprising instructions for the second hardware device is validated using a second attestation protocol. In some embodiments, the first attestation protocol comprises SPDM (Security Protocol and Data Model), and wherein the second attestation protocol comprises DICE (Device Identifier Composition Engine).

### BRIEF DESCRIPTION OF THE DRAWINGS

The present invention(s) is/are illustrated by way of example and is/are not limited by the accompanying figures, in which like references indicate similar elements. Elements in the figures are illustrated for simplicity and clarity, and have not necessarily been drawn to scale.

FIG. 1 is a block diagram depicting certain components of an IHS operable according to various embodiments for initialization using a boot image with independently attestable portions.

FIG. 2 is a block diagram depicting certain partitions of a memory device installed in an IHS, where the partitions are provisioned according to embodiments for initialization of the IHS using a boot image with independently attestable portions.

FIG. 3 is a flow chart diagram illustrating certain steps of a process according to various embodiments for provisioning boot code instructions for initialization of an IHS using a boot image with independently attestable portions.

FIG. 4 is a flow chart diagram illustrating certain steps of a process according to various embodiments for initialization of an IHS using a boot image with independently attestable portions.

### DETAILED DESCRIPTION

For purposes of this disclosure, an IHS may include any instrumentality or aggregate of instrumentalities operable to compute, calculate, determine, classify, process, transmit, receive, retrieve, originate, switch, store, display, communicate, manifest, detect, record, reproduce, handle, or utilize any form of information, intelligence, or data for business, scientific, control, or other purposes. For example, an IHS may be a personal computer (e.g., desktop or laptop), tablet computer, mobile device (e.g., Personal Digital Assistant (PDA) or smart phone), server (e.g., blade server or rack server), a network storage device, or any other suitable device and may vary in size, shape, performance, functionality, and price. An IHS may include Random Access Memory (RAM), one or more processing resources, such as a Central Processing Unit (CPU) or hardware or software control logic, Read-Only Memory (ROM), and/or other types of nonvolatile memory.

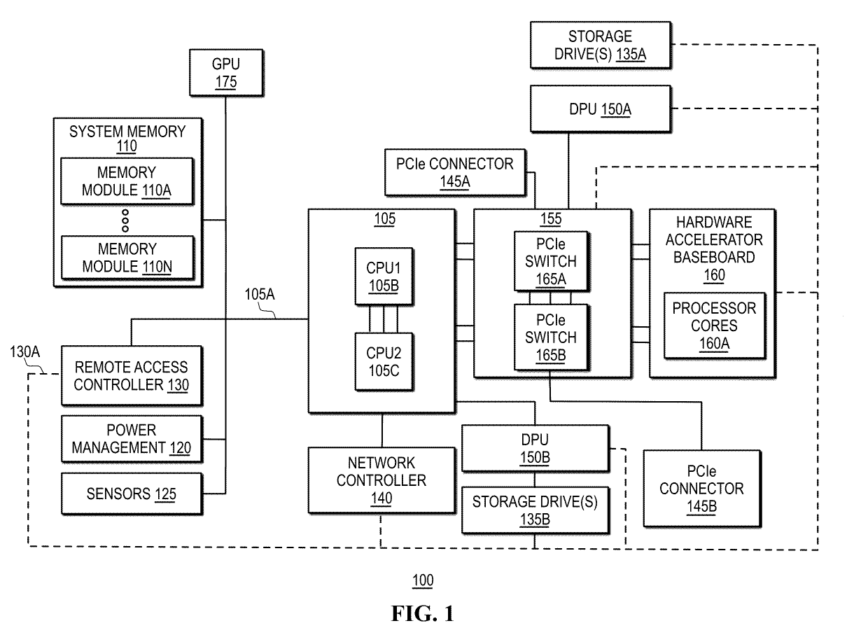

Additional components of an IHS may include one or more disk drives, one or more network ports for communicating with external devices as well as various I/O devices, such as a keyboard, a mouse, touchscreen, and/or a video display. An IHS may also include one or more buses operable to transmit communications between the various hardware components. An example of an IHS is described in more detail below. FIG. 1 shows an example of an IHS configured to implement the systems and methods described herein according to certain embodiments. It should be appreciated that although certain IHS embodiments described herein may be discussed in the context of an enterprise computing device, such as a rack-mounted server, other embodiments may be utilized.

FIG. 1 is a block diagram illustrating certain components of an IHS 100, according to embodiments, that may be operable for initialization using a boot image with independently attestable portions. It should be appreciated that although FIG. 1 describes an IHS such as a rack-mounted server, a variety of other types of IHSs may be implemented according to the embodiments described herein. As described in additional detail below, in embodiments, IHS 100 may be factory-provisioned with boot code instructions, such as a BIOS image that is stored to a persistent memory of the IHS, that includes independently attestable portions, thus allowing different portions of the boot code to be validated using different attestation protocols. For instance, portions of the BIOS image that validate and initialize an individual hardware component may be validated using an attestation protocol specified by the manufacturer of that hardware component, with different hardware components being validated using different attestation protocols that are suitable for validation of respective hardware components. In this manner, the root of trust of an IHS may be constructed using contributions from different entities that provide BIOS instructions that operate within this root of trust.

In some embodiments, IHS 100 may utilize one or more system processors 105, that may also be referred to as CPUs (central processing units). In some embodiments, CPUs 105 may each include a plurality of processing cores that may be separately assigned computing tasks. Each of the CPUs 105 may be individually designated as a main processor and as a co-processor, where such designations may be based on delegation of specific types of computational tasks to a CPU 105. In some embodiments, CPUs 105 may each include an integrated memory controller that may be implemented directly within the circuitry of each CPU 105. In some embodiments, a memory controller may be a separate integrated circuit that is located on the same die as the CPU 105.

Each memory controller may be configured to manage the transfer of data to and from a system memory 110 of the IHS, in some cases using a high-speed memory interface. The system memory 110 is coupled to CPUs 105 via one or more memory buses that provide the CPUs 105 with high-speed memory used in the execution of computer program instructions by the CPUs 105. Accordingly, system memory 110 may include memory components, such as static RAM (SRAM), dynamic RAM (DRAM), NAND Flash memory, suitable for supporting high-speed memory operations by the CPUs 105. In certain embodiments, system memory 110 may combine persistent non-volatile memory and volatile memory.

IHS 100 may utilize a chipset that may be implemented by integrated circuits that are coupled to each CPU 105. All or portions of the chipset may be implemented directly within the integrated circuitry of an individual CPU 105. The chipset may provide the CPU 105 with access to a variety of resources accessible via one or more in-band buses 105a. IHS 100 may also include one or more I/O ports that may be used to couple the IHS 100 directly to other IHSs, storage resources, diagnostic tools, and/or other peripheral components. A variety of additional components may be coupled to CPUs 105 via a variety of busses. For instance, CPUs 105 may also be coupled to a power management unit 120 that may interface with a power system of the chassis in which IHS 100 may be installed. In some instances, CPUs 105 may collect information from one or more sensors 125 via a management bus.

As described, IHS 100 may operate using a BIOS (Basic Input/Output System) that may be stored in a non-volatile memory accessible by the CPUs 105. The BIOS may provide an abstraction layer by which the operating system of the IHS 100 interfaces with hardware components of the IHS. Upon powering or restarting IHS 100, CPUs 105 may utilize BIOS instructions to initialize and test hardware components coupled to the IHS, including both components permanently installed as components of the motherboard of IHS 100 and removable components installed within various expansion slots supported by the IHS 200. The BIOS instructions may also load an operating system for execution by CPUs 105. In certain embodiments, IHS 100 may utilize Unified Extensible Firmware Interface (UEFI) in addition to or instead of a BIOS.

As described in additional detail below, the BIOS used in the operation of an IHS may be loaded from a BIOS image that is factory-provisioned to the IHS. In many existing systems, the BIOS image and/or other boot code instructions are validated monolithically using a single attestation protocol, as selected by a security processor of the IHS that manages boot code attestation operations on behalf of the IHS, where this security processor may be a CPU 105a-b, TPM, remote access controller 130, or other specialized security hardware of the IHS. As described, the BIOS image may include instructions for configurating core operations of the IHS, such as POST (Power-On Self-Test) instructions for confirming critical hardware is functioning correctly and such as instructions for configuring initial power and clock settings of the IHS.

However, the BIOS image may also include instructions for initializing and configuring various hardware components of the IHS, including system memory 110, power controllers 120, PCIe switches 165a-b, storage drives 135a-b, and certain user I/O devices that may include a GPU 175 used in the display of information by the IHS. As such hardware components of an IHS become increasingly sophisticated, monolithic attestation of all such hardware components that are initialized through BIOS image operations is undesirable and forces all such hardware components included in the BIOS image initialization to utilize a single common attestation protocol.

As described in additional detail below, embodiments support use of a BIOS image that includes multiple instructions blocks that may be independently attestable, where the attestation protocol that is used for attestation of portion of the BIOS image may be selected by the entity providing and/or supporting that portion of the BIOS image, such as a portion including instructions for initialization of a specific hardware component of the IHS. Through the use of independently attestable portions of the BIOS image, scalable attestation of the initialization of an IHS is provided by embodiments. Attestation protocols used by an IHS may be selected and modified independently for each of the independently attestable portions of the BIOS image, thus allowing new attestation protocols to be adopted for specific portions of the BIOS image, while retaining the ability to continue attestation of other portions of the BIOS image using existing attestation protocols.

In some embodiments, IHS 100 may include a TPM (Trusted Platform Module) that may include a cryptographic processor used to support various cryptographic capabilities on behalf of the IHS. In some embodiments, the operations of the TPM may be configured through setting various registers, such as platform configuration registers, and the TPM may include various onboard logic and memory components such as a secure NVRAM (Non-Volatile Random-Access Memory) storage. In some embodiments, the TPM may be initialized during booting of the IHS 100 through BIOS image instructions that are specified withing a portion of the BIOS image that is independently attestable, such that the TPM may be validated using an attestation protocol that may be distinct from attestation protocols used in validating other hardware components of the IHS. For instance, in some embodiments, the portion of the BIOS image that includes instructions for the TPM may require attestation using measurements made by the TPM itself, rather than rely on any other security processors of the IHS.

In some embodiments, the cryptographic capabilities of the TMP may be relied upon by the CPU 105a-b, remote access controller 130 and various other hardware components. For instance, the cryptographic capabilities of the TPM may be invoked to calculate hash values that are based on software and/or firmware instructions, thus generating digital measurements of these instructions for use in ensuring their integrity versus a reference measurement made from trusted instructions. In this manner, a TPM may be utilized in establishing a root of trust that includes hardware components of IHS 100 that have been validated as operating using instructions that originate from a trusted source and that these instructions that originate from the trusted source have not been modified. In some embodiments, the various portions of the BIOS image may be designated for validation using attestation protocols supported by the TPM of the IHS.

In the IHS 100 of FIG. 1, CPUs 105 are used to operate a PCIe switch fabric that is used in the operation of PCIe-compliant devices of the IHS, such as PCIe switches 165a-b, SSD storage drives 135a-b, DPUs 150a-b, network controller 140 and hardware accelerator 160. In some embodiments, CPUs 105 may be coupled to a network controller 140, such as provided by a Network Interface Controller (NIC) card that provides IHS 100 with communications via one or more external networks, such as the Internet, a LAN, or a WAN. In some embodiments, network controller 140 may be support network operations by CPUs 105 through a PCIe coupling that is accessible by the chipsets of CPUs 105. In some embodiments, designated portions of the BIOS image that include instructions for initialization of the PCIe switches 165a-b, DPUs 150a-b, network controller 140, SSD storage drives 135a-b and hardware accelerator 160 may be independently attestable during initialization of the IHS.

In some embodiments, these PCIe couplings supported by CPUs 105 may also be used to interface with one or more DPUs 150a-b. Each of the DPUs 150a-b may include a programmable processor that may be configured for offloading functions from CPUs 105. In some instances, DPUs 150a-b may be programmed to offload functions that support the operation of devices or systems that are coupled to IHS 100, thus sparing CPUs 105 from a significant number of interrupts required to support these devices coupled to the IHS and gaining efficiency through the use of specialized implementations of these offloaded functions that can be achieved using the programmable logic of the DPUs 150a-b. In other embodiments, DPUs 150a-b may implement operations in support of storage drives 135a-b and other types of devices and may similarly support high-bandwidth PCIe connections with these devices. For instance, in various embodiments, DPUs 150a-b may support high-bandwidth PCIe connections with networking devices in implementing functions of a network switch, compression and codec functions, virtualization operations or cryptographic functions.

In some embodiments, DPUs 150a-b may include a plurality of programmable processing cores and/or hardware accelerators, that may be used to implement functions used to support devices coupled to the IHS 100. DPUs 150a-b may also include one more memory devices that may be used to store program instructions executed by the processing cores and/or used to support the operation of SSD storage drives 135a-b, such as in implementing cache memories and buffers utilized in support of the storage drives. In some embodiments, the processing cores of DPUs 150a-b include ARM (advanced RISC (reduced instruction set computing) machine) processing cores. In other embodiments, the cores of DPUs 150a-b may include MIPS (microprocessor without interlocked pipeline stages) cores, RISC-V cores, or CISC (complex instruction set computing) (i.e., x86) cores.

In the IHS 100 of FIG. 1, PCIe switches 165a-b are coupled via PCIe connections to one or more hardware accelerator cores 160a that may be connected to the IHS via one or more hardware accelerators 160. Embodiments may include one or more hardware accelerators 160, where each hardware accelerators 160 may be coupled to one or more of the PCIe switches 165a-b, and where each hardware accelerator 160 may include one or more cores 160a. Each of the cores may be a programmable processing core and/or hardware accelerator that can be configured for offloading certain functions from CPUs 105. For instance, PCIe switches 165a-b may transfer instructions and data for generating video images between one or more cores 160a and CPUs 105. In processing this graphics data, cores 160a, each of which may be individual GPU cores, may include hardware-accelerated processing capabilities that are optimized for performing streaming calculation of vector data, matrix data and/or other graphics data.

As described, IHS 100 may include a remote access controller 130 that supports remote management of IHS 100 and of various internal components of IHS 100. In certain embodiments, remote access controller 130 may operate from a different power plane from the CPUs 105 and from other components of IHS 100, thus allowing the remote access controller 130 to operate, and management tasks to proceed, while the processing cores of IHS 100 are powered off. In some embodiments, various initialization functions of the IHS, including launching the BIOS and operating system of the IHS 100, may be implemented by the remote access controller 130. In such embodiments, the remote access controller 130 may be tasked with validation of the BIOS image such that the hardware components initialized using the BIOS image are properly attested as part of the root-of-trust of the IHS 100. In some embodiments, remote access controller 130 may be tasked with various other forms of attestation of all or portions of the BIOS image, such as in support of live scan operations by which periodic and/or event-driven attestation requests may be implemented by the remote access controller. In various embodiments, remote access controller 130 may support various other operations that include attestation of all or parts of the BIOS image, such as in support of recovery operations and in response to threat indicators. As described in additional detail below, the remote access controller 130 may be configured to perform attestation of the BIOS image, where the remote access controller initiates and manages the independent attestation of distinct portions of the BIOS image that have been designated for attestation using a specific protocol.

Remote access controller 130 may include a service processor, or specialized microcontroller, that operates management software that provides remote monitoring and administration of IHS 100. Remote access controller 130 may be installed on the motherboard of IHS 100, or may be coupled to IHS 100 via an expansion slot connector provided the IHS. In support of remote monitoring functions, remote access controller 130 may include a dedicated network adapter that may support sideband management connections 130a by remote access controller 130 using wired and/or wireless network technologies.

In some embodiments, remote access controller 130 may support monitoring and administration of various managed devices of an IHS via a sideband bus interface 130a. For instance, messages utilized in device management may be transmitted using I2C sideband bus 130a connections that may be established with each of the managed devices. These managed devices of IHS 100, such as specialized hardware, network controller(s) 240, hardware accelerator 160, hardware accelerator 180, and storage drives 135a-b, may be connected to the CPUs 105 via in-line buses, such as the described PCIe switch fabric, that is separate from the I2C sideband bus 130a connections used by the remote access controller 130 for device management.

In various embodiments, an IHS 100 does not include each of the components shown in FIG. 1. In various embodiments, an IHS 100 may include various additional components in addition to those that are shown in FIG. 1. Furthermore, some components that are represented as separate components in FIG. 1 may in certain embodiments instead be integrated with other components. For example, in certain embodiments, all or a portion of the functionality provided by the illustrated components may instead be provided by components integrated into the one or more processor(s) 105 as a systems-on-a-chip.

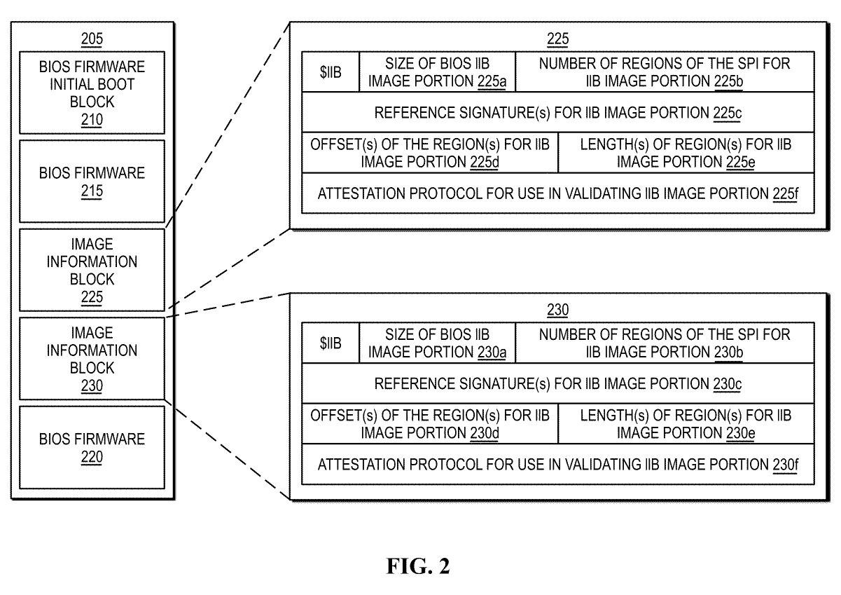

FIG. 2 is a block diagram depicting certain partitions of a memory device 205 installed in an IHS 100, where the partitions are provisioned according to embodiments for initialization of the IHS using a boot image that includes independently attestable portions. As described in additional detail below, a BIOS image that includes the binary instructions for use in initializing and operating the BIOS may be stored during factory provisioning of the IHS 100 to persistent memory device 205 of an IHS 100, such as a Flash memory device or another form of NVRAM persistent storage. In embodiments where the memory device 205 is a Flash memory device, such a Flash device may be accessed using the SPI (Serial Peripheral Interface) protocol in order to validated the stored BIOS image, and in particular for the independent attestation of the various portions of the BIOS image.

As described with regard to FIG. 1, attestation of the BIOS image stored in the SPI Flash may be managed by a CPU 105a-b, remote access controller 130, TPM or other logic unit of the IHS 100 that has been designated for attestation of the boot image. In some embodiments, the processor managing the attestation process may rely on another processor of the IHS to perform cryptographic measurements of the instructions the comprise distinct portions of the BIOS image, where the processor used to generate such measurements may be specified as part of the attestation protocol specified for validation of a particular portion of the BIOS image.

As indicated in FIG. 2, the memory device 205 used to store the BIOS image may be subdivided into distinct partitions. As described above, the BIOS image stored in a SPI-accessible Flash of an IHS may include instructions for initialization of core system functions of the IHS, such as clock settings, but may also include instructions for initialization of individual hardware components of the IHS, such as initializing memory devices and storage drives that will be used in continuing booting of the IHS 100. Rather than rely on a single monolithic attestation of the stored BIOS image, embodiments utilize independently attestable portions of the BIOS image that may be validated separately from each other, including both authenticity of the instructions as originating from a trusted source and verifying the integrity of the instructions as unchanged from a reference set of instructions provided by the trusted source.

In the illustrated embodiment, the memory device 205 storing the BIOS image includes two BIOS Image Information Blocks (IIBs) 225, 230. In some embodiments, the IIBs 225, 230 that are included in a the stored BIOS image may be specified in an initial BIOS boot block 210 that may include core BIOS initialization instructions and instructions support the independent attestation of the IIBs. In some embodiments, IIBs 225, 230 may provide a map of code blocks stored memory device 205 that can be validated individually as a distinct portion of the BIOS image.

In existing systems, such IIB code blocks may be individually validated, but all code blocks are validated using the same attestation protocol and all validations are conducted on the IHS itself, or are all conducted remotely. In embodiments, independently attestable partitions of the BIOS image may be specified by IIBs 225, 230, where each IIB specifies the attestation protocol for use in validating a specific portion of the stored BIOS image. For instance, an IIB for an independently attestable partition of the BIOS image may specify local TPM attestation of a portion of the boot image, while another IIB for another independently attestable partition of the BIOS image may specify local DICE (Device Identifier Composition Engine) attestation for that portion of the boot image, while another IIB for another independently attestable partition of the BIOS image may specify remote SPDM (Security Protocol and Data Model) attestation of that portion of the boot image.

Although not illustrated, each IIB 225, 230 may include a header or other fields identifying the IIB and various other information describing the different regions of the memory device 205 that store portions of the BIOS image to validated using the IIB. As indicated in FIG. 2, each IIB 225, 230 may include information specifying the size 225a, 230a of the respective IIB partition that is to be validated according to the instructions and other information specified in the respective IIB. Also as indicated, each IIB 225, 230 may include information specifying the number of different regions of the memory device 205 that include instructions for validation using the instructions and other information specified in the respective IIB. In the illustrated embodiment, each region of the memory device 205 that includes instructions for validation as part of an IIB 225, 230 may be specified through an offset 225d, 230d within the memory device 205 at which a region begins, and also though a specified length 225e, 230e of each respective region of the memory device, thus providing the address range(s) of each region of the storage boot image to be validated using each of the IIBs 225, 230.

As indicated, each IIB 225, 230 includes one or more reference signature(s) generated from trusted BIOS image instructions that are validated by the respective IIB. In some embodiments, the IIB 225, 230 may include a pointer or other memory reference to a reference signature for an IIB. As described in additional detail below, the BIOS image that is stored to the memory device 205 during factory provisioning of the IHS 100 may include IIBs that were generated during creation of the BIOS image. Each of these factory provisioned IIBs 225, 230 may be generated to include a reference signature that is generated from trusted instructions for each IIB. For instance, a respective IIB 225, 230 may include a signature that is a hash value generated based on the trusted instruction for the IIB, which may be referred to as a measurement of these instructions. As described in additional detail below, once the BIOS image generated in this manner has been stored to the memory device 205 during factory provisioning and the IHS is delivered and deployed, these reference measurements may be compared to measurements of the instructions in the various regions specified in the IIB 225, 230, thus validating each of the portions of the BIOS image.

Rather than rely on a uniform attestation of the BIOS image stored in the memory device 205, in embodiments, the IIB 225, 230 specify the attestation protocol 225f, 230f to be used in independently validating the portion of the BIOS image that is identified by the IIB. The attestation protocol 225f, 230f specified for an IIB may specify the type of measurement to be conducting in validating the portion of the BIOS image identified by the IIB, where the type of measurement may identify a specific security processor of the IHS to be used in conducting the measurement, such as specifying measurements by the CPU, TPM, remote access controller, and may specify a particular protocol to be used in the attestation, such as SPDM, DICE, etc. As new attestation protocols become available, such as the use of quantum algorithms or AI-based approaches, individual IIBs may specify use of such emerging attestation protocols for individual portions of the BIOS image, while continuing use of existing protocols for other portions of the BIOS image. In this manner, the most suitable attestation protocol may be utilized for each independently attestable portion of the stored BIOS image.

As described, each IIB 225, 230 may specify a number of different regions 225b, 230b that are to be validated according to the attestation protocol 225f, 230f specified for each respective IIB 225, 230. For instance, in the illustrated embodiments, the regions 225b specified in IIB 225 may identify the portion of the BIOS image stored in region 215 of the memory device, while the regions 230b specified in IIB 230 may identify the portion of the BIOS image stored in region 220 of the memory device. Embodiments may include any distribution of BIOS image portion within the memory device. In some embodiments, different IIBs 225, 230 may specify attestation of overlapping regions of the BIOS stored in the memory device 205. For instance, both regions 225b in IIB 225 and regions 230b in IIB 230 may specify validation of the same portion of the BIOS image stored in region 215.

In this manner, different IIBs may be used in supporting redundant attestation of certain portions of the BIOS image. During initialization of the IHS, such redundancy may be unnecessary. However, as described above, components such as remote access controller 130 may support live and/or on-demand attestation of portions of the BIOS image such that only certain portions of the BIOS image may be validated in some instances. Embodiments thus support overlapping IIBs that may be use to validate the same region of the BIOS image, where each IIB utilizes an attestation protocol that is appropriate for the context, such as use of lightweight DICE attestation during live scans using one IIB and use of more robust SPDM attestation during booting.

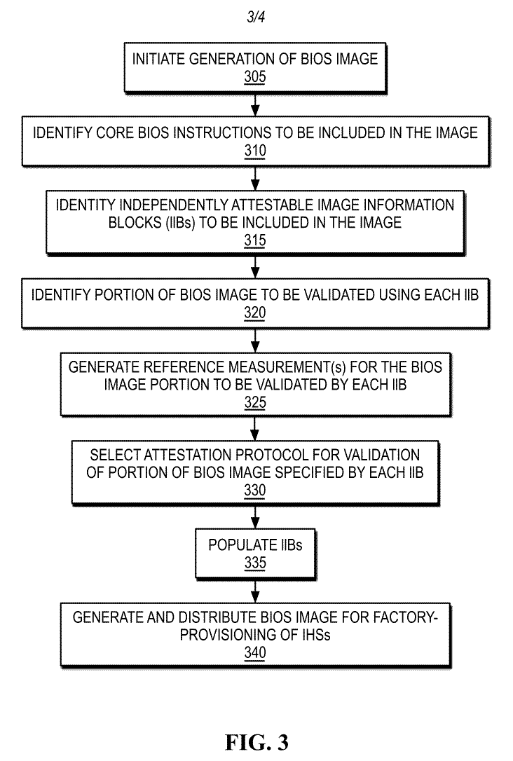

FIG. 3 is a flow chart diagram illustrating certain steps of a process according to various embodiments for provisioning boot code instructions for initialization of an IHS using a boot image with independently attestable portions. As indicated, embodiments may begin, at 305, by initiating the generation of a BIOS image, where this image will be uploaded to newly manufactured IHSs as part of their factory provisioning. As such, the generation of the BIOS image according to FIG. 3 may be conducted long before the BIOS image is loaded to an IHS and utilized.

In order to generate the BIOS image, at 310, the core BIOS instructions to be included in the image are identified. As described in FIG. 2, a BIOS image may include an initial boot block 210 that includes instructions for preliminary system initializations. In addition, support for certain BIOS operations, such as live scans, may be implemented through BIOS image instructions that are included in the BIOS image. With the system-level BIOS instructions identified, embodiments may continue, at 315, with the identification of multiple IIBs to be included in the BIOS image, with each IIB corresponding to an independently attestable portion of the BIOS image.

For each IIB, at 320, the corresponding portions of the BIOS image to be validated based on the IIB are identified. As describe above, portions of the BIOS image specified in an IIB may be a continuous region of the memory device 205, or may be spread across multiple distinct regions of the memory device, including overlapping with regions that may be validated by other IIBs. Once the address ranges for portion of the BIOS image have been identified, at 325, reference measurements are generated for those BIOS instructions, such as using a hashing algorithm that may be supported by one or more attestation protocols. At 330, the attestation protocol is identified for use in validating this portion of the BIOS image against the generated reference measurement. As described, the attestation protocol that is selected may specify the processor to be used in generating measurements to be validated against the reference measurement, such as specifying the TPM, CPU, remote access controller, a remote attestation service, etc. In some embodiments, the processor to be used may be specified, without requiring use of any specific attestation algorithm, such as DICE or SPDM. In some embodiments, the specified attestation protocol may require use of a particular algorithm by a specific processor.

At 335, the IIBs are populated with the address ranges of the corresponding portion of the BIOS image, the attestation protocol to be used, the reference signature for the portion of the BIOS image to be validated against, as well as other information described with regard to the stored BIOS image of FIG. 2. Once the IIBs have been populated, at 340, any remaining general portions of the BIOS image may generated, with these general portions and the IIBs combined to generate a BIOS image file that is distributed to factory provisioning facilities for installation in newly manufactured IHSs.

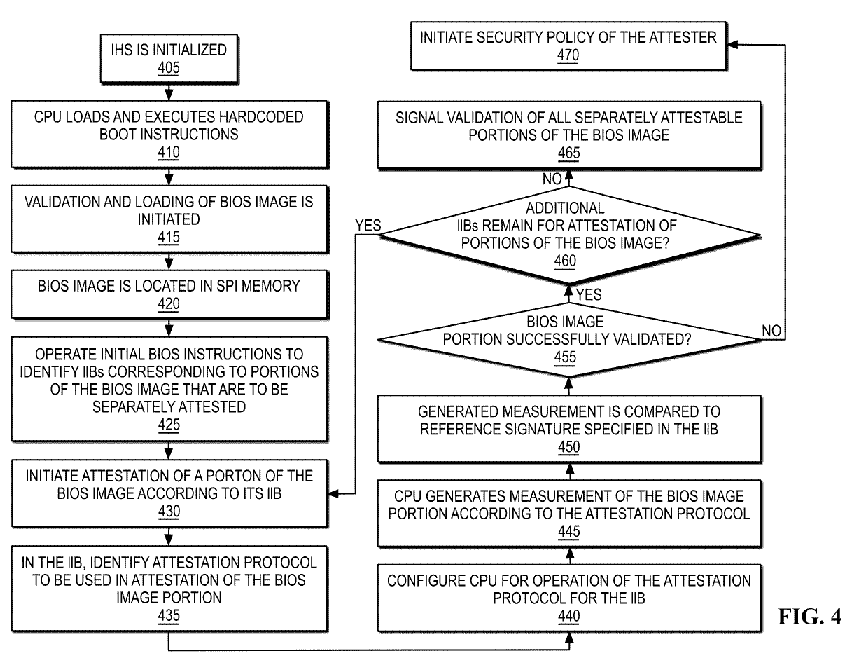

FIG. 4 is a flow chart diagram illustrating certain steps of a process according to various embodiments for initialization of an IHS using a boot image with independently attestable portions. As indicated, embodiments may begin, at 405, with the initialization of an IHS 100, such as described with regard to FIG. 1, where the IHS 100 has been factory provisioned with a BIOS image, such as stored in the memory device 205 of FIG. 2, with this BIOS image generated in the manner described with regard to FIG. 3. Embodiments of FIG. 4 that utilize the IIBs in attestation of the BIOS image may begin with the initialization of the IHS, such as upon the IHS being powered or re-started.

Upon the IHS being powered, certain core hardware components of the IHS may be powered and the boot sequence of the IHS may be initiated, at 410, based on hardcoded boot code instructions utilized by the CPU 105a-b that is responsible for initializing and booting the IHS, such as based on masked instructions of an onboard ROM of this CPU. From these instructions, some initial configurations of the CPU and system memory may be conducted. After a requisite amount of initialization, at 415, these hardcoded boot code instructions are used to initiate loading and operation of the BIOS from the BIOS image that has been stored in a memory device 205 of the IHS 100, such as a SPI-accessible Flash memory device.

From the hard-coded boot instruction, at 420, the location of the stored BIOS image is identified, such as within a SPI-accessible Flash memory device of the IHS 100. The BIOS image may be stored within a continuous region of the memory device 205, or may be disbursed across multiple regions of the memory device 205. As described with regard to FIG. 2, the distribution of the stored BIOS image within the memory device 205 may be specified within an initial boot block 210 of the memory device. In particular, the initial boot block 210 may specify one or more BIOS IIBs (Image Information Blocks) 225, 230 that are stored in the memory device 205, with each IIB specifying an independently attestable portion of the BIOS image that is stored in the memory device, and also specifying the attestation protocol to be used in validating that particular portion of the BIOS image.

From such boot block 210 instructions, at 425, one or more IIBs 225, 230 corresponding to independently attestable portions of the BIOS image are identified. At 430, the first IIB 225 is parsed and evaluated in initiating attestation of a first portion of the stored BIOS image. As described, each IIB 225, 230 may specify information describing the storage of a portion of the stored BIOS image, such as the locations of various stored blocks of data that comprise the portion of the BIOS image. Also as described, each IIB 225, 230 specifies one or more reference signature(s) 225c, 230c, for validating a respective portion of the BIOS image and also specifies the attestation protocol 225f, 230f to be used in validating that portion of the BIOS image.

Accordingly, based on information parsed from the first IIB 225, at 435, the attestation protocol to be used in validating a first portion of the BIOS image is identified. As described, any attestation protocol supported by the IHS, or that may be remotely supported by the IHS may be specified for use within an independently attestable IIB 225, 230 according to embodiments. As described, each IIB may specify an attestation protocol that may specify the processor (e.g., CPU, TPM, remote access controller, etc.) to be used in generating measurements of the BIOS image for the IIB and may specify the cryptographic technology to be used in generating the measurements (e.g., SPDM, DICE, etc.).

Once the attestation protocol for the first IIB 225 has been identified, at 440, the CPU or other security processor performing the cryptographic operations of the attestation may be configured for operation of the selected attestation protocol. As described, attestation of software instructions, such as a portion of the stored BIOS image, may be conducted through the use of digital measurements of the stored BIOS instructions and through the comparison of these measurements versus a reference signature 225c, 230c specified in the IIBs 225, 230 for each independently attestable portion of the stored BIOS image.

In some embodiments, such measurements of the stored BIOS instructions may be conducted by a CPU 105a-b of the IHS. In such embodiments, the CPU 105a-b may be configured to perform code measurements according to a specific attestation protocol, such as configuring the CPU for remote SPDM attestation through a network connection that has been established with remote attestation service that may be operated to support validation of all IIBs 225, 230 of a stored BIOS image, or that may be operated to support validation of a specific portion(s) of the stored BIOS image for only some of the IIBs. In other instances, the CPU may be configured for local attestation, such as using DICE attestation using the local TPM for measurement of the portion of the BIOS image.

In some embodiments, the CPU or other processor performing the measurements of the BIOS instructions manages the attestation of the stored BIOS image. In other embodiments, the CPU is utilized in performing measurements of code, but the attestation of the stored BIOS image and the independently attestable portions of the BIOS image may be managed by the remote access controller 130 of the IHS, whether as part of booting the IHS and/or in support of live attestation capabilities. Accordingly, in some embodiments, the remote access controller 130 may be tasked with BIOS initialization and/or later validation of the BIOS instructions that are in use. In such embodiments, the remote access controller 130 may initiate attestation of a portion of the BIOS image, but may rely on the CPU or TPM or other processor of the IHS with cryptographic capabilities to perform the measurements of the instructions to be validated. Accordingly, in some embodiments, the remote access controller 130 may configure the CPU or TPM for use in performing measurements for a portion of the instructions of the BIOS image based on the attestation protocol specified in the IIB for this portion of the BIOS image.

With the CPU or other cryptographic security processor of the IHS configured for conducting the specified attestation protocol, at 445, the CPU generates the requested measurement of the instructions of the portion of the BIOS image specified in the IIB. For instance, the CPU may generate a hash value based on these instructions from a portion of the BIOS image, where this hash value may be calculated according the attestation protocol for this IIB portion of the BIOS. As described, the measurement of a portion of the BIOS image may be conducted remotely from the IHS in some scenarios, such that the BIOS image to validated may be transmitted for measurement by a remote security system, such as a cryptographic system that is trusted by the entity providing and/or supporting this portion of the BIOS image.

For instance, in a scenario where a portion of the BIOS image corresponds to instructions for initializing a specific storage device, such as a drive 135a-b storing addition boot instruction, the attestation protocol for this portion of the BIOS image may specify remote attestation where measurement and evaluation of these measurements versus a reference signature are conducted remote from the IHS by the entity that supports this particular storage drive. Similarly, a portion of the BIOS image corresponding to specialized hardware accelerator 160 may be validated according to a robust attestation protocol such as SPDM. In this manner, embodiments, support particularized attestation of BIOS instructions utilized by specific hardware components of an IHS.

Once the portion of the BIOS image of the first IIB 225 has been measured, at 450, the generated measurement is compared to the reference measurement 225c specified in the IIB for this portion. In some embodiments, the comparison of the generated measurement versus reference measurements 225c, 230c are conducted by the remote access controller 130 or other processor that is managing the attestation of the stored BIOS image. In other embodiments, the comparison of the generate measurement versus reference measurement 225c, 230c may be conducted by the security processor that generates the measurement, such as by the CPU or TPM.

At 455, the portion of the stored BIOS image 215, 220 is determined as valid based on the comparison to the respective reference measurement 225c, 230c. As indicated, in scenarios where the portion of the stored BIOS image is deemed to be authentic and unmodified, embodiments may return, at 430, to the evaluation of another independently attestable portion of the BIOS image, as specified in a subsequent IIB 230 of the IIBs that were factory-provisioned to the memory device 205, such as to a SPI-accessible Flash, of the IHS 100. As described, the subsequent IIB 230 may specify use of a different attestation protocol from the prior IIB 225, thus allowing each IIB to utilize the most appropriate attestation protocol for each portion of the stored BIOS image.

For instance, in one scenario an independently attestable portion of the BIOS image specified in a first IIB 225 may correspond to initialization instructions for network controller 140, where such initializations are performed to support use of remote attestation protocols by subsequent IIBs 230. In such a scenario, the first IIB 225 may specify use of local attestation by the TPM for the BIOS initialization instructions for the network controller 140. In some embodiments, the first IIB 225 may specify a specific protocol to be used by the TPM, while other embodiments may only require attestation by the TPM without restriction on the protocol used by the TPM.

Continuing this illustrative scenario, the subsequent IIB 230 may correspond to BIOS initialization instructions for a PCIe switch 155 of the IHS. With the BIOS initializations for the network controller 140 completed upon attestation according to the prior IIB 225, the second IIB 230 may specify use of a remote attestation protocol, such as remote attestation using transmission of attestation data via SPDM. In this manner, different portions of the BIOS image may be validated using different attestation protocols, thus allowing attestation to be tailored to the hardware components being initialized in each independently attestable portion of the BIOS image, and also tailored to the attestation capabilities that are available during that boot phase based on already validated instructions.

In this manner, embodiments may continue iterating through any number of IIBs, each specifying an independently attestable portion of the BIOS image. If no additional IIBs remain for attestation of portions of the BIOS image, at 465, embodiments may signal completion of this phase of the BIOS attestation and initialization. With these independently attestable portions of the BIOS image validated, embodiments may continue with any remaining BIOS validations and initializations before handing off continued booting of the IHS, such as booting of an operating system of the IHS.

As indicated in FIG. 4, at 470, in some scenarios, portions of the stored BIOS image may not be successfully validated. In some instances, updates to the BIOS image may have been made without corresponding updates to the IIBs 225, 230 used to validate the effected portions of the BIOS image, thus resulting in the IIB and associated portion of the BIOS image being out of sync. In some instances, the instructions of a portion of the stored BIOS image may have been modified either purposefully by a malicious actor, or accidently through an inadvertent operation. In some instances, an IIB may be modified without a corresponding change to the relevant portion(s) of the BIOS image. In all such instances, a portion of the BIOS image may not be successfully validated.

In such instances, embodiments may support the initiation of security policies of the hardware component that is managing the attestation of the BIOS image. For instance, in scenarios where the remote access controller 130 is managing attestation of the BIOS image, with cryptographic measurements and evaluation being conducted by the CPU and/or TPM, failure to validate a portion of the boot image may result in the invocation of security polices of the remote access controller 130. For instance, the remote access controller 130 may invoke policies that revert to use of prior validated BIOS instructions upon failure to validate a portion of the BIOS image. In some embodiments, the remote access controller 130 may invoke different security policies based on the hardware component that is being initialized using the instructions that have not been successfully validated. For instance, the remote access controller 130 may halt further booting of the IHS in response to a failure to validate BIOS image instructions for initializing a specific SSD storage drive that stores instructions for booting an operation system of an IHS, while generating warnings, notifications and quarantines while allowing booting of the IHS to continue in response to failure to validate BIOS instructions for initializing a keyboard, mouse or other basic I/O component of the IHS.

In some embodiments, the remote access controller 130 may invoke different security policies based on the context in which the validation failure has occurred. As described, validation of a BIOS image instructions may be conducted upon initialization of an IHS, but may also be repeated at various times by the IHS, such as in response to a user or other administrative request to scan the IHS to identify the use of any unauthorized instructions. In some embodiments, the remote access controller 130 may invoke one security policy to halt further booting of an IHS upon detecting a failure to validate a portion of the BIOS image during powering initialization of the IHS, while invoking a different security policy to quarantine operations by a specific hardware component of the IHS upon a live scan resulting in a failure to validate the BIOS instructions related to that hardware component. In this manner, different security policies may be used to tailor the response to the validation failure.

It should be understood that various operations described herein may be implemented in software executed by processing circuitry, hardware, or a combination thereof. The order in which each operation of a given method is performed may be changed, and various operations may be added, reordered, combined, omitted, modified, etc. It is intended that the invention(s) described herein embrace all such modifications and changes and, accordingly, the above description should be regarded in an illustrative rather than a restrictive sense.

The terms “tangible” and “non-transitory,” as used herein, are intended to describe a computer-readable storage medium (or “memory”) excluding propagating electromagnetic signals; but are not intended to otherwise limit the type of physical computer-readable storage device that is encompassed by the phrase computer-readable medium or memory. For instance, the terms “non-transitory computer readable medium” or “tangible memory” are intended to encompass types of storage devices that do not necessarily store information permanently, including, for example, RAM. Program instructions and data stored on a tangible computer-accessible storage medium in non-transitory form may afterwards be transmitted by transmission media or signals such as electrical, electromagnetic, or digital signals, which may be conveyed via a communication medium such as a network and/or a wireless link.

Although the invention(s) is/are described herein with reference to specific embodiments, various modifications and changes can be made without departing from the scope of the present invention(s), as set forth in the claims below. Accordingly, the specification and figures are to be regarded in an illustrative rather than a restrictive sense, and all such modifications are intended to be included within the scope of the present invention(s). Any benefits, advantages, or solutions to problems that are described herein with regard to specific embodiments are not intended to be construed as a critical, required, or essential feature or element of any or all the claims.

Unless stated otherwise, terms such as “first” and “second” are used to arbitrarily distinguish between the elements such terms describe. Thus, these terms are not necessarily intended to indicate temporal or other prioritization of such elements. The terms “coupled” or “operably coupled” are defined as connected, although not necessarily directly, and not necessarily mechanically. The terms “a” and “an” are defined as one or more unless stated otherwise. The terms “comprise” (and any form of comprise, such as “comprises” and “comprising”), “have” (and any form of have, such as “has” and “having”), “include” (and any form of include, such as “includes” and “including”) and “contain” (and any form of contain, such as “contains” and “containing”) are open-ended linking verbs. As a result, a system, device, or apparatus that “comprises,” “has,” “includes” or “contains” one or more elements possesses those one or more elements but is not limited to possessing only those one or more elements. Similarly, a method or process that “comprises,” “has,” “includes” or “contains” one or more operations possesses those one or more operations but is not limited to possessing only those one or more operations.

1. An Information Handling System (IHS) comprising:
one or more processors;
a memory device coupled to the one or more processors, the memory device storing instructions that, upon loading and execution by a first of the processors upon booting of the IHS, causes the first processor to:
identify one or more partitions of the memory device that store boot code of the IHS;
identify partitions of the memory device that comprise independently attestable boot code, wherein an independently attestable partition designates an attestation protocol for use in validating boot code of the respective partition; and
utilize an attestation protocol designated for each independently attestable partition for validating boot code of a respective partition.

2. The IHS of claim 1, wherein the boot code of a partition is validated through comparison of a measurement of the boot code versus a reference measurement for the boot code of the partition.

3. The IHS of claim 2, wherein the attestation protocol designated for an independently attestable partition specifies the first processor of the IHS to perform the measurement of the boot code.

4. The IHS of claim 2, wherein the first processor comprises a CPU of the IHS and wherein the CPU generates the measurements of the boot code.

5. The IHS of claim 2, wherein the first processor comprises a TPM of the IHS, and wherein a remote access controller invokes the TPM of the IHS to generate the measurements of the boot code.

6. The IHS of claim 1, wherein, when the boot code stored in an independently attestable partition is validated, the boot code is added to a root of trust of the IHS.

7. The IHS of claim 1, wherein the boot code comprises BIOS (Basic Input/Output System) instructions.

8. The IHS of claim 7, wherein a first independently attestable partition of the memory device that stores BIOS instructions comprises instructions for initialization of a first hardware device of the IHS and wherein a second independently attestable partition of the memory device that stores BIOS instructions comprises instructions for initialization of a second hardware device of the IHS.

9. The IHS of claim 8, wherein the first independently attestable partition comprising instructions for the first hardware device is validated using a first attestation protocol, and wherein the second independently attestable partition comprising instructions for the second hardware device is validated using a second attestation protocol.

10. The IHS of claim 9, wherein the first attestation protocol comprises SPDM (Security Protocol and Data Model), and wherein the second attestation protocol comprises DICE (Device Identifier Composition Engine).

11. A method for secure initialization of an Information Handling System (IHS) comprising a memory device for storing boot code of the IHS, the method comprising:
identifying one or more partitions of the memory device that store boot code of the IHS;
identifying partitions of the memory device that comprise independently attestable boot code, wherein an independently attestable partition designates an attestation protocol for use in validating boot code of the respective partition; and
utilizing an attestation protocol designated for each independently attestable partition for validating boot code of a respective partition.

12. The method of claim 11, wherein the boot code of a partition is validated through comparison of a measurement of the boot code versus a reference measurement for the boot code of the partition.

13. The method of claim 12, wherein the attestation protocol designated for an independently attestable partition specifies the first processor of the IHS to perform the measurement of the boot code.

14. The method of claim 11, wherein, when the boot code stored in an independently attestable partition is validated, the boot code is added to a root of trust of the IHS.

15. The method of claim 11, wherein the boot code comprises BIOS (Basic Input/Output System) instructions.

16. A computer-readable memory device having instructions stored thereon for secure initialization of an Information Handling System (IHS), wherein, upon loading of the instruction by a processor of the IHS, execution of the instructions causes the processor to:
identify one or more partitions of the memory device that store boot code of the IHS;
identify partitions of the memory device that comprise independently attestable boot code, wherein an independently attestable partition designates an attestation protocol for use in validating boot code of the respective partition; and
utilize an attestation protocol designated for each independently attestable partition for validating boot code of a respective partition.

17. The computer-readable memory device of claim 16, wherein the boot code of a partition is validated through comparison of a measurement of the boot code versus a reference measurement for the boot code of the partition.

18. The computer-readable memory device of claim 17, wherein the attestation protocol designated for an independently attestable partition specifies the first processor of the IHS to perform the measurement of the boot code.

19. The computer-readable memory device of claim 16, wherein, when the boot code stored in an independently attestable partition is validated, the boot code is added to a root of trust of the IHS.

20. The computer-readable memory device of claim 16, wherein the boot code comprises BIOS (Basic Input/Output System) instructions.
